(19) United States
(12) Patent Application Publication
(10) Pub. No.: US 2024/0029571 A1
(43) Pub. Date: Jan. 25, 2024

(54) FLIGHT SUPPORT APPARATUS, FLIGHT SUPPORT PROGRAM, AND FLIGHT SUPPORT SYSTEM

(71) Applicant: JAPAN AEROSPACE EXPLORATION AGENCY, Tokyo (JP)

(72) Inventors: Tomoko IIJIMA, Tokyo (JP); Yoshinori MATSUNO, Tokyo (JP); Noboru MOTOYAMA, Tokyo (JP); Koji ITO, Tokyo (JP)

(21) Appl. No.: 18/245,369

(22) PCT Filed: Sep. 1, 2021
(86) PCT No.: PCT/JP2021/032140

§ 371 Date: Mar. 15, 2023

(30) Foreign Application Priority Data
Oct. 15, 2020 (JP) 2020-173814

(51) Int. Cl. G08G 5/00

(52) U.S. Cl. CPC G08G 5/0021; G08G 5/0039

(57) ABSTRACT

A flight support apparatus includes a flight support unit that displays a reference flight profile that is a flight profile as a reference, the flight profile indicating a flight specification at a plurality of spots included in a path from a departure place to a destination, corrects the reference flight profile according to a flight condition input by a user to prepare a corrected flight profile, and displays the prepared corrected flight profile together with the reference flight profile.

### TECHNICAL FIELD

The present invention relates to a flight support apparatus, a flight support program, and a flight support system that support a flight by a pilot.

### BACKGROUND ART

There are proposed airborne systems of aircraft, which aim at achieving both a 4D-flight that improves an airspace capacity (an operation in which an aircraft passes through a particular spot at a specified time of day) and a fuel-efficient flight that reduces environment loads, and which display an optimal path to a pilot by using weather information (Patent Literatures 1 to 3 and Non-Patent Literature 1).

### CITATION LIST

### Patent Literature

Patent Literature 1: U.S. Pat. No. 8,977,482
Patent Literature 2: U.S. patent Ser. No. 10/102,756
Patent Literature 3: Japanese Patent Application Laid-open No. 2003-034300

### Non-Patent Literature

Non-Patent Literature 1: Sharon E. Woods, et al., “Traffic Aware Planner for Cockpit-based Trajectory Optimization”, AIAA Aviation Forum 13-17 Jun. 2016

### DISCLOSURE OF INVENTION

### Technical Problem

In an actual operation, a pilot may voluntarily change a flight path and specification by the pilot's own determination, and thus it is thought that the intention of the operation by the pilot is unsuitable in conventional technologies in which the system side presents flight paths and specifications unilaterally. In this regard, it is desirable to provide a system capable of not only presenting flight paths and specifications unilaterally by the system side but also making decision on the flight paths and specifications by cooperation of the system and the pilot.

In view of the circumstances as described above, it is an object of the present invention to provide a flight support apparatus, a flight support program, and a flight support system that are capable of supporting a flight by cooperating with a pilot.

### Solution to Problem

A flight support apparatus according to an embodiment of the present invention includes a flight support unit that displays a reference flight profile that is a flight profile as a reference, the flight profile indicating a flight specification at a plurality of spots included in a path from a departure place to a destination, corrects the reference flight profile according to a flight condition input by a user to prepare a corrected flight profile, and displays the prepared corrected flight profile together with the reference flight profile.

In this embodiment, the flight support apparatus displays the corrected flight profile together with the reference flight profile, so that situation awareness of the user (pilot) is enhanced and the user easily selects an optimal corrected flight profile. This achieves a cooperative decision on a flight path by the flight support apparatus and the pilot. In other words, this makes it possible to make decision on the flight path by cooperation of the flight support apparatus and the pilot, instead of unilaterally presenting a flight path to the user. This makes it possible for the flight support apparatus to support a flight by cooperating with the pilot.

The flight profile is a line obtained by, when one of axes in two-dimensional coordinates is a distance from the departure place and another axis is the flight specification, connecting points each indicating the distance and the flight specification at the plurality of spots.

In this embodiment, the corrected flight profile and the reference flight profile are graphically shown on the two-dimensional coordinates of the distance and the flight specification, and thus the user easily understands a difference in flight specification or time between the corrected flight profile and the reference flight profile. This enhances situation awareness of the user and makes it easy for the user to select an optimal corrected flight profile.

The flight support unit corrects the corrected flight profile again according to a flight condition input by the user to prepare another corrected flight profile, and displays the other corrected flight profile prepared together with the reference flight profile and the corrected flight profile before corrected again.

Thus, the corrected flight profile presented by the flight support apparatus is further corrected again by the determination of the user, so that a flight profile that is optimized and intended by the user is prepared. This achieves a more cooperative decision on the flight path by the flight support apparatus and the pilot. In other words, the user further partially changes the flight profile presented by the flight support apparatus, so that it is possible to cooperatively decide a flight profile and cooperatively support the flight.

The flight support unit prepares a plurality of sample flight profiles having different flight specifications from the reference flight profile, plots equal time-of-arrival points on the reference flight profile and the plurality of sample flight profiles, the equal time-of-arrival points being spots for which an arrival at an identical time of day is predicted when a flight is performed using the reference flight profile and the plurality of sample flight profiles, connects the plurality of equal time-of-arrival points plotted to prepare an equal time-of-arrival line, and displays the prepared equal time-of-arrival line to intersect with or come into contact with the reference flight profile and the corrected flight profile.

The intersection point at which each of the reference flight profile and the corrected flight profile intersects with or comes into contact with the equal time-of-arrival line indicates a spot where the aircraft is located (arrives) at an identical time of day. With the equal time-of-arrival line as an index, the user can compare the times of arrival in the plurality of flight profiles, which is effective in the operation. The user can intuitively understand the difference between the reference flight profile and the corrected flight profile by referring to the equal time-of-arrival line, and can thus more easily select an optimal corrected flight profile.

The flight support unit prepares a plurality of sample flight profiles having different flight specifications from the reference flight profile, plots equal remaining-fuel points on the reference flight profile and the plurality of sample flight profiles, the equal remaining-fuel points being spots for which an identical amount of the remaining fuel is predicted when a flight is performed using the reference flight profile and the plurality of sample flight profiles, connects the plurality of equal remaining-fuel points plotted to prepare an equal remaining-fuel line, and displays the prepared equal remaining-fuel line to intersect with or come into contact with the reference flight profile and the corrected flight profile.

The intersection point at which each of the reference flight profile and the corrected flight profile intersects with or comes into contact with the equal remaining-fuel line indicates a spot having an identical amount of the remaining fuel. With the equal remaining-fuel line as an index, the user can compare the amounts of the remaining fuel in the plurality of flight profiles, which is effective in the operation. The user can intuitively understand the difference between the reference flight profile and the corrected flight profile by referring to the equal remaining-fuel line, and can thus more easily select an optimal corrected flight profile.

The flight support unit proposes that the user selects one corrected flight profile of the corrected flight profiles as the reference flight profile newly set.

This makes it possible to make decision on the flight path by cooperation of the flight support apparatus and the pilot, instead of unilaterally presenting a flight path to the user.

The flight support unit displays one corrected flight profile, which is selected by the user from the corrected flight profiles, as the reference flight profile newly set.

The flight support apparatus sets the corrected flight profile, which is prepared according to the flight condition input by the user, as a new reference flight profile. This achieves a cooperative decision on a flight path by the flight support apparatus and the pilot. In other words, this makes it possible to make decision on the flight path by cooperation of the flight support apparatus and the pilot, instead of unilaterally presenting a flight path to the user.

The flight condition input by the user includes at least one spot of the plurality of spots and a flight specification in a path including the at least one spot.

The user can input a flight condition that means a flight with a particular flight specification in a path including a particular spot. This makes it possible for the flight support apparatus to prepare a flight profile closed to the user's desire. This further makes it possible to make decision on the flight path by cooperation of the flight support apparatus and the pilot.

The flight condition input by the user includes at least one of fuel efficiency priority, comfortableness priority, punctuality priority, earliest arrival priority, or balance priority between at least two of them.

This makes it possible for the flight support apparatus to automatically prepare and display a flight profile according to the viewpoint intended by the user.

The flight support unit prepares the corrected flight profile on the basis of information relating to a flight environment.

The flight support apparatus can prepare the corrected flight profile in real time, for example, on the basis of weather forecast data and flight data and further information obtained by correcting those pieces of data, as the information relating to the flight environment.

The flight support apparatus further includes an acceleration sensor, in which the flight support unit determines a shake of the flight support apparatus on the basis of an acceleration detected by the acceleration sensor, and corrects the information relating to the flight environment on the basis of the shake.

This makes it possible for the flight support apparatus to determine a shake of the flight support apparatus on the basis of the acceleration detected by the built-in acceleration sensor and to calculate a shake of the aircraft. The flight support apparatus can correct the information relating to the flight environment in real time during flight on the basis of the calculated shake of the aircraft. This makes it possible to prepare the corrected flight profile more suitably on the basis of the real-time information.

A flight support program according to an embodiment of the present invention causes a control circuit of a flight support apparatus to: display a reference flight profile that is a flight profile as a reference, the flight profile indicating a flight specification at a plurality of spots included in a path from a departure place to a destination, correct the reference flight profile according to a flight condition input by a user to prepare a corrected flight profile, and display the prepared corrected flight profile together with the reference flight profile.

A flight support system according to an embodiment of the present invention includes: a server that collects information relating to a flight environment and supplies the information to an flight support apparatus; and the flight support apparatus including a control circuit that displays a reference flight profile that is a flight profile as a reference, the flight profile indicating a flight specification at a plurality of spots included in a path from a departure place to a destination, corrects the reference flight profile according to a flight condition input by a user on the basis of the information relating to the flight environment to prepare a corrected flight profile, and displays the prepared corrected flight profile together with the reference flight profile.

### Advantageous Effects of Invention

According to the present invention, it is possible to provide a flight support apparatus, a flight support program, and a flight support system that are capable of supporting a flight by cooperating with a pilot.

Note that the effects described herein are not necessarily limited and may be any of the effects described in the present disclosure.

### BRIEF DESCRIPTION OF DRAWINGS

FIG. 1 schematically shows a flight support system according to an embodiment of the present invention.

FIG. 2 shows a functional configuration of the flight support system.

FIG. 3 shows a hardware configuration of an flight support apparatus.

FIG. 4 shows an operation flow of the flight support apparatus.

FIG. 5 schematically shows an operation of the flight support apparatus.

FIG. 6 shows an example of a flight support screen.

FIG. 7 shows an example of the flight support screen.

FIG. 8 shows an example of the flight support screen.

FIG. 9 shows an example of the flight support screen.

FIG. 10 shows an example of the flight support screen.

FIG. 11 shows an example of the flight support screen.

FIG. 12 shows another example of the flight support screen.

FIG. 13 shows another example of the flight support screen.

FIG. 14 shows another example of the flight support screen.

FIG. 15 shows examples of an equal time-of-arrival line and an equal remaining-fuel line.

### MODE(S) FOR CARRYING OUT THE INVENTION

Hereinafter, an embodiment of the present invention will be described with reference to the drawings.

### 1. Flight Support System

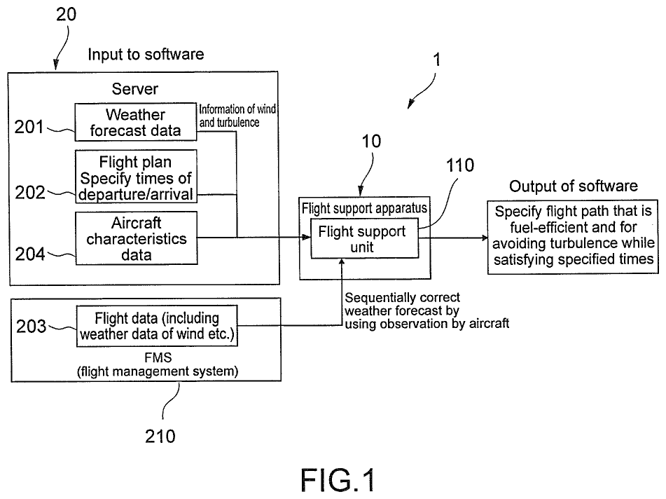

FIG. 1 schematically shows a flight support system according to an embodiment of the present invention.

A flight support system 1 includes a flight support apparatus 10 and a server 20. The flight support apparatus 10 and the server 20 are mutually communicable via a network such as the Internet.

The flight support apparatus 10 is typically a mobile device such as a tablet computer. The flight support apparatus 10 is a so-called electronic flight bag (EFB). Typically, a user of the flight support apparatus 10 is a pilot (hereinafter, referred to as user in some cases). The pilot (user) carries the flight support apparatus 10 to the cockpit of the aircraft and uses it during flight. The flight support apparatus 10 operates as a flight support unit 110 by executing a flight support program.

The server 20 collects information relating to an flight environment and supplies the information to the flight support apparatus 10. The information relating to an flight environment includes weather forecast data 201. The weather forecast data 201 includes information of wind, turbulence, and the like. The server 20 further supplies flight plan data 202 including a time of departure and a time of arrival and aircraft characteristics data 204 to the flight support apparatus 10. The server 20 is a server system and is not limited to the single apparatus. Flight data 203 is further input to the flight support apparatus 10 from a flight management system (FMS) 210 outside the server 20. The flight data 203 is data including weather data of wind and the like and obtained by sequentially correcting a weather forecast through observation by the aircraft. Further, the flight data 203 is data including position information of the aircraft and sequentially updated. Note that the time of departure and the time of arrival may be extracted from the flight plan data 202 or input to the flight support apparatus 10 by the user.

The flight support apparatus 10 calculates a flight path on the basis of the weather forecast data 201 and the flight data 203 and the time of departure and the time of arrival included in the flight plan data 202. Specifically, the flight support apparatus 10 calculates and outputs a fuel-efficient flight path or a flight path for avoiding turbulence on the basis of the weather forecast data 201 and the flight data 203 while satisfying the time of departure and the time of arrival included in the flight plan data 202. In this embodiment, the “flight path” includes an altitude at a plurality of spots (waypoints) included in the path from a departure place to a destination.

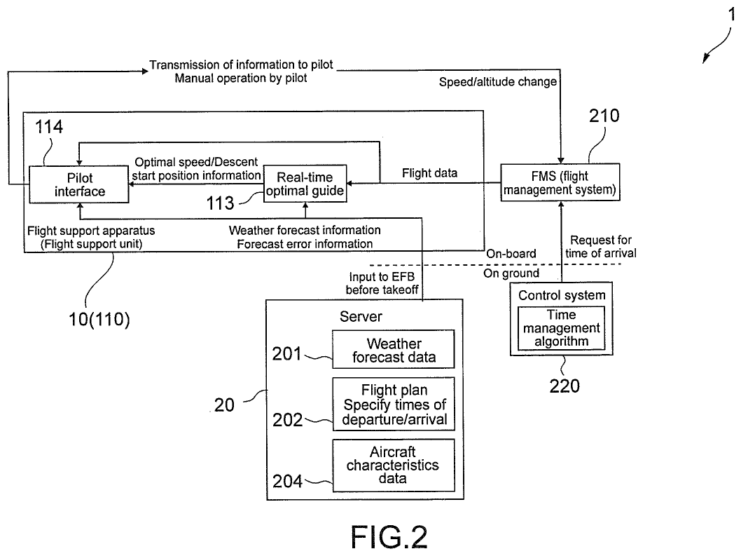

FIG. 2 shows a functional configuration of the flight support system.

The server 20 supplies the weather forecast data 201, the flight plan data 202, and the aircraft characteristics data 204 to the flight support apparatus 10, for example, via a network. The flight management system 210 located outside the server 20 supplies various types of information such as the flight data 203 to the flight support apparatus 10, for example, via a network. Note that the flight management system 210 and the flight support apparatus 10 are not connected to be communicable in some cases. In this case, basically, the aircraft to which the flight support apparatus 10 is carried flies along the flight plan data 202 prepared by the server 20, and the aircraft position is manually updated by the user or automatically updated with the position information of the flight support apparatus 10.

The flight support unit 110 of the flight support apparatus 10 estimates aircraft characteristics in real time and corrects information relating to a flight environment in real time. For example, the flight support apparatus 10 determines a shake of the flight support apparatus 10 on the basis of an acceleration detected by an acceleration sensor 18 and calculates a shake of the aircraft (the flight support apparatus 10 is located inside the cockpit of the aircraft). The flight support apparatus 10 corrects the information relating to the flight environment in real time during flight on the basis of the calculated shake of the aircraft.

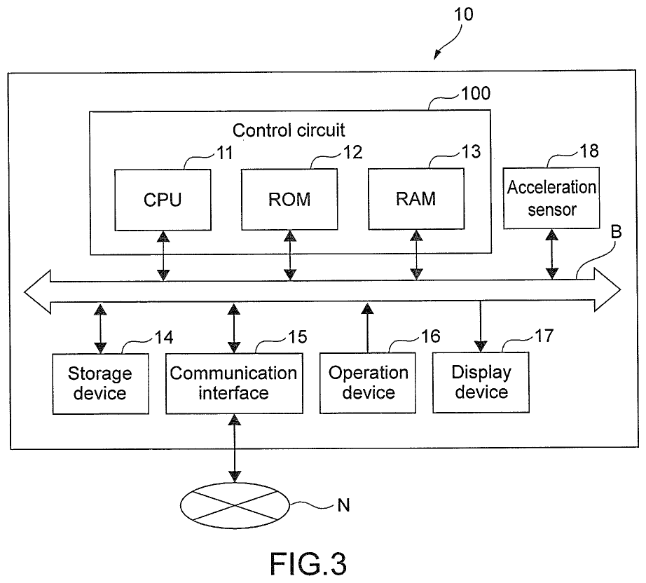

The flight support apparatus 10 calculates an optimal flight path 113 in real time on the basis of the estimated aircraft characteristics, the corrected information relating to the flight environment and an error thereof, and flight information including the time of departure and the time of arrival included in the flight plan 202. The optimal flight path 113 includes an optimal speed, descent start position information, and the like. The flight support unit 110 outputs the optimal flight path 113 to a pilot interface 114 to propose the optimal flight path 113 and guide the user. The hardware that implements the pilot interface 114 is a display device of the flight support apparatus 10 (FIG. 3).

### 2. Hardware Configuration of Flight Support Apparatus

FIG. 3 shows a hardware configuration of the flight support apparatus.

The flight support apparatus 10 includes a control circuit 100, a storage device 14, a communication interface 15, an operation device 16, a display device 17, the acceleration sensor 18, and a bus B that connects those components.

The control circuit 100 is a system-on-a-chip (SoC) including a central processing unit (CPU) 11, a read only memory (ROM) 12, and a random access memory (RAM) 13. The CPU 11 loads a flight support program stored in the ROM 12 to the RAM 13 and executes the flight support program. The ROM 12 fixedly stores programs, data, and the like to be executed by the CPU 11. The ROM 12 is an example of a non-transitory computer-readable recording medium. The control circuit 100 further includes a dedicated hardware circuit, a graphics processing unit (GPU), and the like (not shown).

The storage device 14 includes a large-scale nonvolatile recording medium such as (Solid State Drive).

The operation device 16 includes a touch panel, various switches, and the like. The operation device 16 detects an operation from the user and outputs the operation to the CPU 11. The operation device 16 is an embodiment of an input device. The flight support apparatus 10 may further include a sound input device such as a microphone.

The display device 17 includes an LCD, an organic EL display, or the like integrated with a touch panel. The display device 17 performs arithmetic processing on the basis of information received from the control circuit 100 and displays generated image signals on the screen. The display device 17 is an embodiment of an output device. The flight support apparatus 10 may further include a sound output device such as a speaker.

The communication interface 15 is an interface for connecting to a network N such as the Internet.

The acceleration sensor 18 detects an acceleration.

### 3. Operation Flow of Flight Support Apparatus

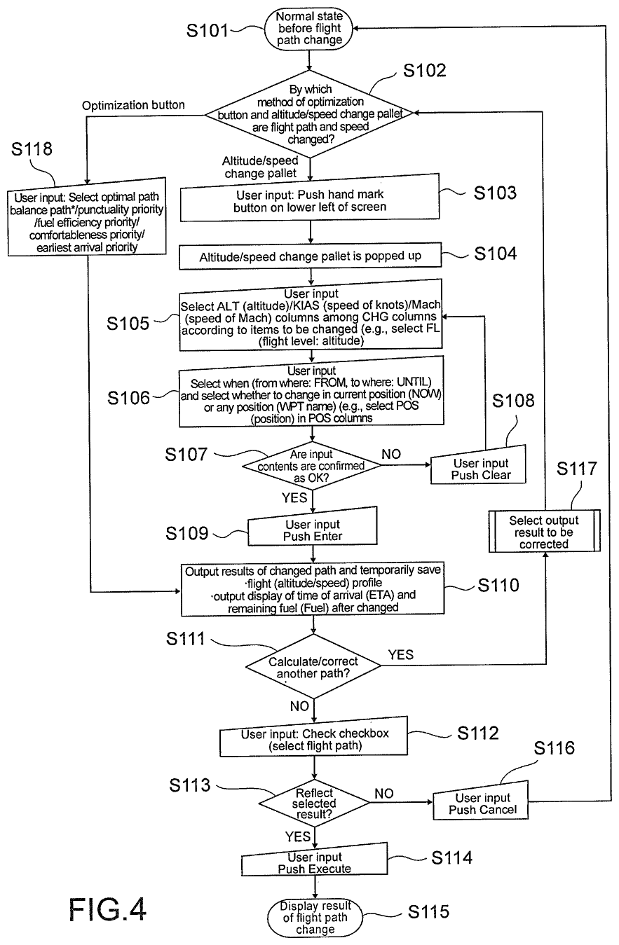

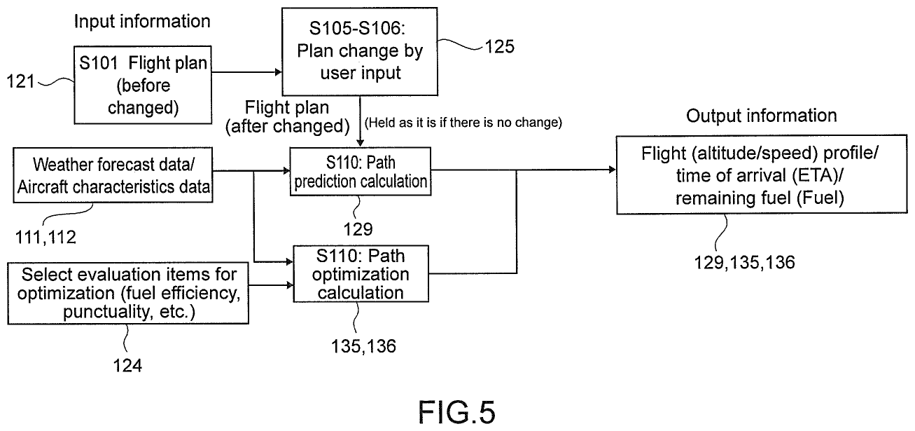

FIG. 4 shows an operation flow of the flight support apparatus. FIG. 5 schematically shows the operation of the flight support apparatus.

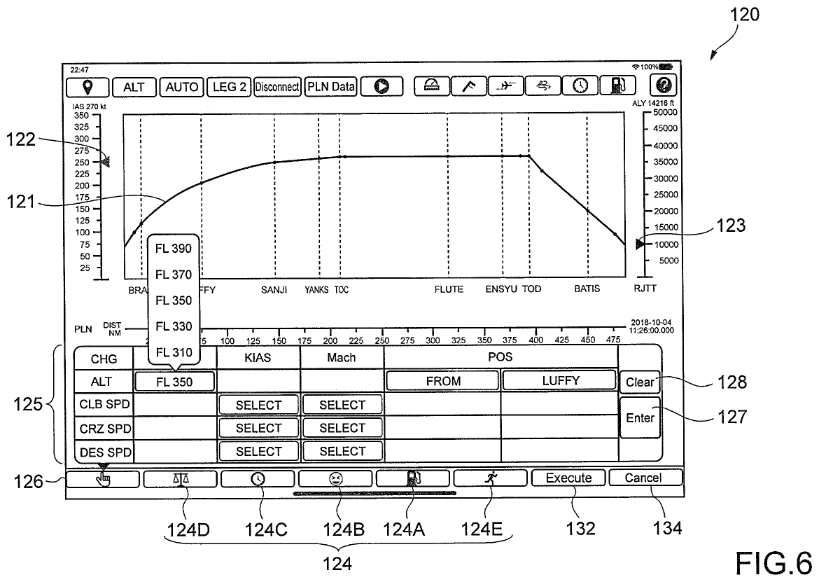

FIG. 6 shows an example of a flight support screen.

The flight support apparatus 10 displays a flight profile as a reference (reference flight profile 121) on a flight support screen 120 of the display device 17 (Step S101). The flight profile graphically shows a flight path. The flight profile includes a flight specification at a plurality of spots (waypoints) included in a path from a departure place (not shown) to a destination RJTT. The flight specification is, for example, an altitude, a speed, or a position in the horizontal direction of the aircraft. In this embodiment, the flight specification will be described as the altitude of the aircraft. More specifically, the flight profile is a line connecting, when one of axes in two-dimensional coordinates (horizontal axis) is a distance NM from a departure place and the other axis (vertical axis) is a flight specification (in this embodiment, altitude FT), points each indicating the distance NM and the flight specification (in this embodiment, altitude FT) at the plurality of spots. The reference flight profile 121 is typically a flight profile prepared as initial settings by a control system included in the server 20 or the flight management system. A speed indicator 122 and an altitude indicator 123 respectively indicate a speed KT and an altitude FT at any point on the flight profile 121.

The user (pilot) inputs a flight condition for correcting the reference flight profile 121. Specifically, the user can input a flight condition by operating either an optimization button group 124 or a pallet 125 (Step S102). The optimization button group 124 includes a fuel efficiency priority button 124A, a comfortableness priority button 124B, a punctuality priority button 124C, an earliest arrival priority button 124E, a balance priority button 124D, and the like. The fuel efficiency priority means that priority is given to a fuel efficiency, that is, a large amount of fuel remaining at a predetermined point of time. The punctuality priority means that priority is given to an arrival at a planned time of arrival. The earliest arrival priority means that priority is given to an early arrival. The balance priority means that priority is given to a balance between at least two of the above priorities (e.g., balance between fuel efficiency and punctuality). When the user operates any one button of the optimization button group 124, for example, the fuel efficiency priority button 124A, the flight support apparatus 10 automatically calculates a (fuel-efficient) flight profile with the fuel efficiency priority. On the other hand, when the pallet 125 is used, the flight support apparatus 10 calculates a flight profile on the basis of a value manually input by the user.

If the user wants to input a flight condition by operating the pallet 125, the user operates a manual button 126 (Step S103). In that case, as shown in the figure, the pallet 125 is popped up from the manual button 126 (Step S104). The pallet 125 includes, as items CHG that can be manually changed, columns of an altitude ALT, an instructed airspeed KIAS, and a speed Mach. In the figure, the user selects FL 350 (=35000 FT) as the altitude ALT from the five levels of FL 310 to FL 390 and inputs it (Step S105).

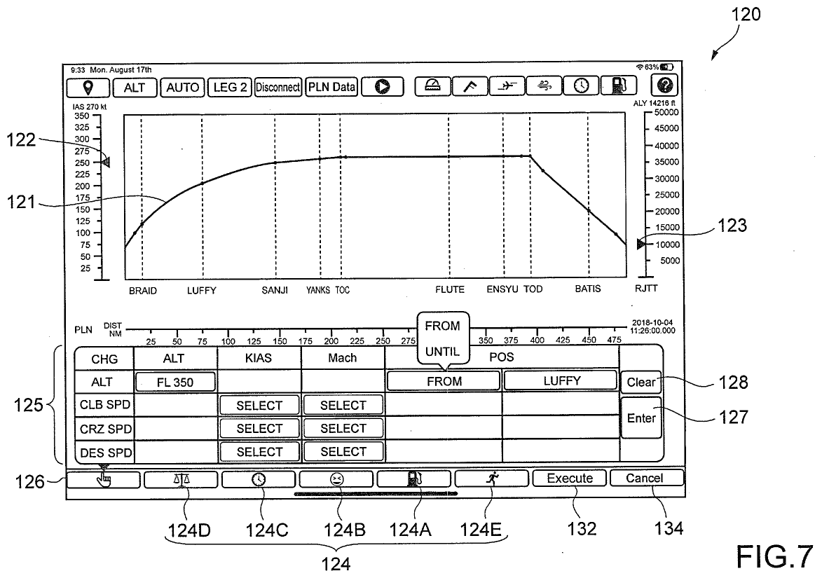

FIG. 7 shows an example of the flight support screen.

Subsequently, the user selects either a start point FROM or an end point UNTIL as a spot POS. In the figure, the user selects a start point FROM as the spot POS (Step S106).

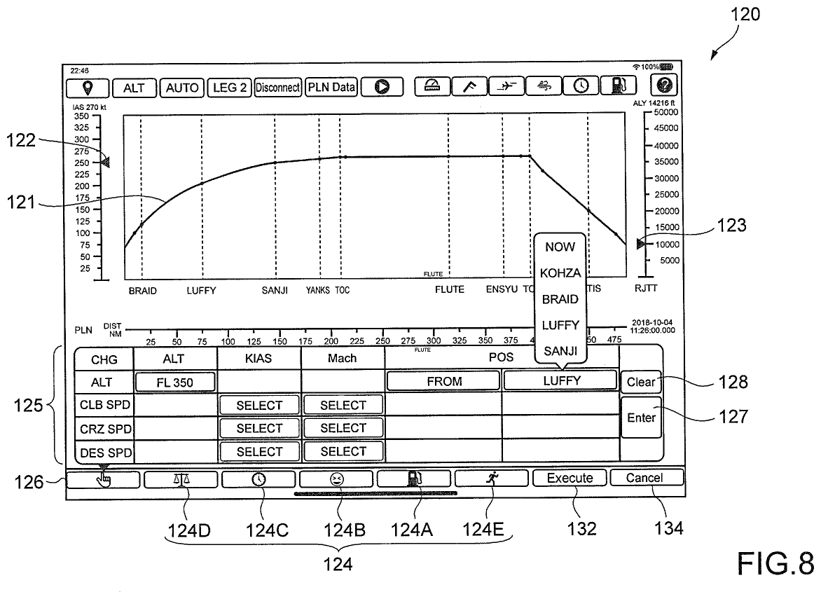

FIG. 8 shows an example of the flight support screen.

Subsequently, the user selects either a spot (waypoint) to the destination RJTT or a current position NOW as the start point FROM. In the figure, the user selects a spot FLUTE as the start point FROM (Step S106). Note that not only the current position NOW or any spot (waypoint) but also a top of climb TOC or a descent start point (top of descent) TOD may be selected as the start point FROM.

The user confirms the flight conditions manually input (altitude ALT=FL 350, start point FROM=spot FLUTE) (Step S107). Such flight conditions mean a flight at the altitude FL 350 through a path including the spot FLUTE as the start point. The user operates a Clear button 128 if the input flight conditions are not OK (Step S108), and inputs flight conditions again (Step S105 to Step S106). Meanwhile, the user operates an Enter button 127 if the input flight conditions are OK (Step S109). In that case, the flight support apparatus 10 terminates the popped-up display of the pallet 125.

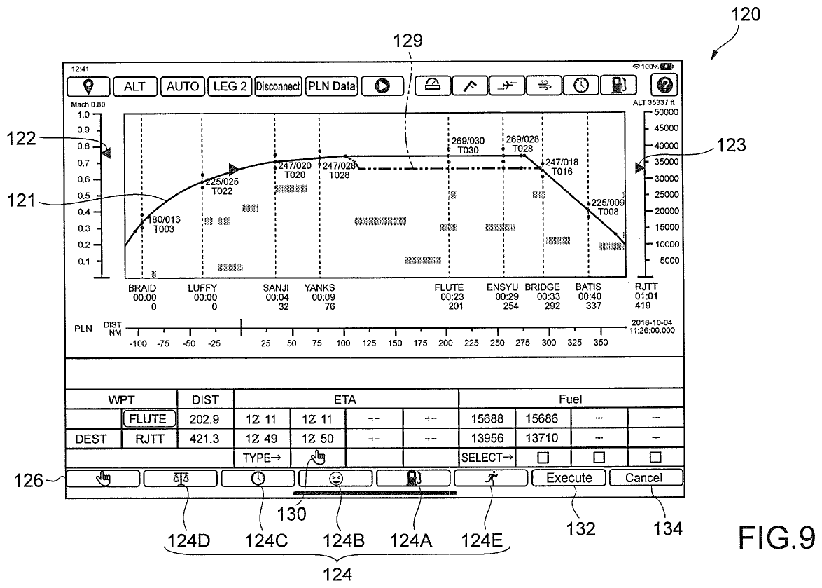

FIG. 9 shows an example of the flight support screen.

The flight support apparatus 10 corrects the reference flight profile 121 according to the flight conditions input by the user (altitude ALT=FL 350, start point FROM=spot FLUTE) to prepare a corrected flight profile 129, and temporarily saves the corrected flight profile 129. The flight support apparatus 10 prepares the corrected flight profile 129 on the basis of estimated aircraft characteristics and a corrected weather forecast (information relating to a flight environment). The flight support apparatus 10 displays the prepared corrected flight profile 129 together with the reference flight profile 121. Specifically, the corrected flight profile 129 is displayed in a different line type (color, broken line, and the like) from the reference flight profile 121. In the figure, the corrected flight profile 129 indicates a flight at the altitude FL 350 (=35000 FT) from the spot FLUTE at the latest to a forward descent start point. The flight support apparatus 10 calculates and displays an estimated time of arrival ETA “12:11” and a remaining fuel Fuel “15686 LB” of the spot FLUTE and an estimated time of arrival ETA “12:50” and an remaining fuel Fuel “13710 LB” of the destination RJTT when the flight is performed according to the corrected flight profile 129 (Step S110). A manual icon 130 is further displayed, which indicates that the estimated time of arrival ETA is manually input.

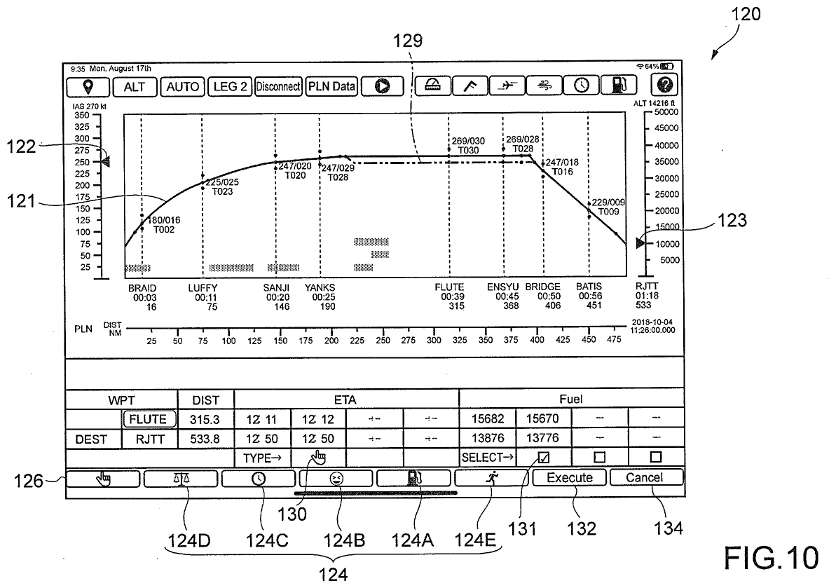

FIG. 10 shows an example of the flight support screen.

The user confirms the corrected flight profile 129, the estimated time of arrival ETA, and the remaining fuel Fuel. The user determines whether or not another corrected flight profile is prepared in addition to the corrected flight profile 129 or whether or not the corrected flight profile 129 is corrected again (Step S111). If the user does not need to prepare another corrected flight profile and to correct the corrected flight profile 129 again (Step S111, NO), the user checks a checkbox 131 indicating the corrected flight profile 129 to be selected (Step S112).

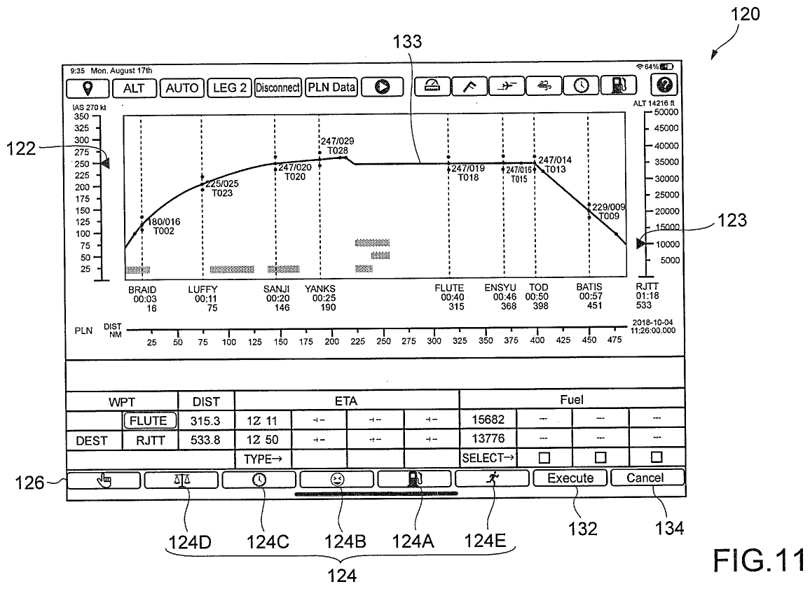

FIG. 11 shows an example of the flight support screen.

The user determines whether to set the corrected flight profile 129, which is selected by checking the checkbox 131, as a new reference flight profile (Step S113). In other words, the user determines whether to perform a flight according to the selected corrected flight profile 129. If the corrected flight profile 129 is set as a new reference flight profile (that is, the flight is performed according to the corrected flight profile 129) (Step S113, YES), the user operates an Execute button 132 (Step S114). In that case, the flight support apparatus 10 deletes the display of the former reference flight profile 121, regarding the path in which the corrected flight profile 129 exists. The flight support apparatus 10 then displays the corrected flight profile 129 as a new reference flight profile 133. In other words, the flight support apparatus 10 displays the corrected flight profile 129 in the line type identical to that of the former reference flight profile 121 and thus displays the corrected flight profile 129 as a new reference flight profile 133 (Step S115).

On the other hand, if the corrected flight profile 129 is not set as a new reference flight profile (that is, the flight is not performed according to the corrected flight profile 129) (Step S113, NO), the user operates a Cancel button 134 (Step S116). In that case, the flight support apparatus 10 deletes the corrected flight profile 129 temporarily saved and displayed, and also deletes the estimated time of arrival ETA and the remaining fuel Fuel for the flight to be performed according to the corrected flight profile 129. The flight support apparatus 10 restores the flight support screen 120 to a state in which only the reference flight profile 121 is displayed (Step S101).

Meanwhile, the user wants to prepare another corrected flight profile or correct the corrected flight profile 129 again in some cases (Step S111, YES). In this case, if the user wants to perform correction again with the corrected flight profile 129 as a reference, the user selects the corrected flight profile 129 to be corrected again (Step S117). In this case, the flight support apparatus 10 corrects the corrected flight profile 129 again according to a flight condition to be input by the user to prepare another corrected flight profile (not shown), and displays the other corrected flight profile prepared (not shown) together with the reference flight profile 121 and the corrected flight profile 129 before corrected again. Meanwhile, if the user wants to prepare a new corrected flight profile with the former reference flight profile 121 as a reference, the user omits Step S117.

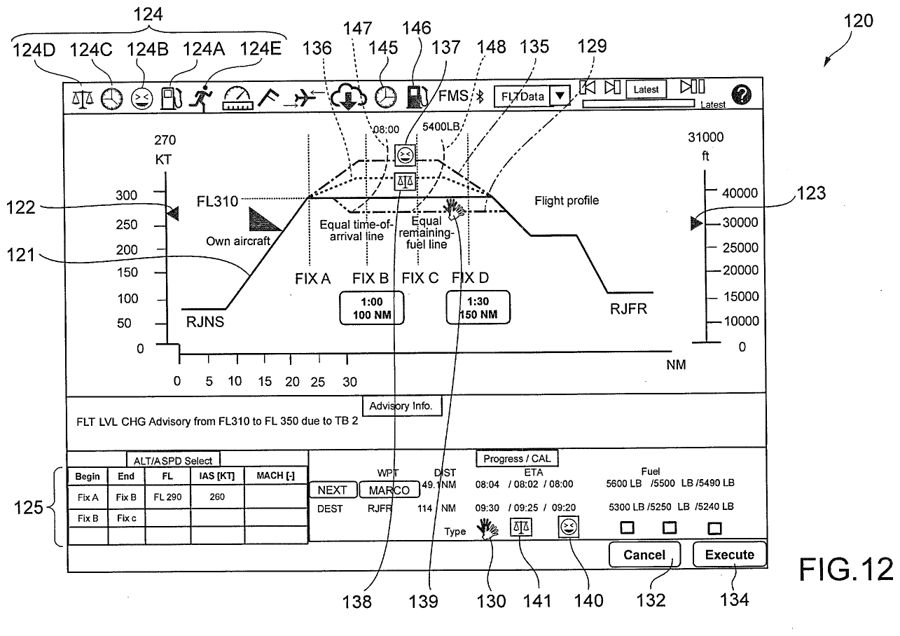

FIG. 12 shows another example of the flight support screen.

The user operates either the optimization button group 124 or the pallet 125 to input a flight condition for correcting the reference flight profile 121 (Step S102). The optimization button group 124 includes the fuel efficiency priority button 124A, the comfortableness priority button 124B, the punctuality priority button 124C, the earliest arrival priority button 124E, the balance priority button 124D, and the like. In this example, the user operates the comfortableness priority button 124B and the balance priority button 124D (Step S118).

The flight support apparatus 10 corrects the reference flight profile 121 according to the flight conditions input by the user (comfortableness priority and balance priority) to prepare a corrected flight profile 135 for comfortableness priority and a corrected flight profile 136 for balance priority and to temporarily save them. The flight support apparatus 10 prepares the corrected flight profile 135 for comfortableness priority and the corrected flight profile 136 for balance priority on the basis of aircraft characteristics and a weather forecast (information relating to a flight environment). The flight support apparatus 10 displays the corrected flight profile 135 for comfortableness priority, the corrected flight profile 136 for balance priority, and the corrected flight profile 129 manually input in advance, together with the reference flight profile 121. Specifically, the corrected flight profile 135 for comfortableness priority, the corrected flight profile 136 for balance priority, the corrected flight profile 129 manually input, and the reference flight profile 121 are all displayed in different line types (color, broken line, and the like). A comfortableness priority icon 137 is displayed for the corrected flight profile 135 for comfortableness priority. A balance priority icon 138 is displayed for the corrected flight profile 136 for balance priority. A manual icon 139 is displayed for the corrected flight profile 129 manually input.

The flight support apparatus 10 calculates and displays an estimated time of arrival ETA “08:00” and a remaining fuel Fuel “5490 LB” of the next spot MARCO and an estimated time of arrival ETA “09:20” and a remaining fuel Fuel “5240 LB” of a destination RJFR when the flight is performed according to the corrected flight profile 135 for comfortableness priority. A comfortableness priority icon 140 indicating the corrected flight profile 135 for comfortableness priority is displayed. The flight support apparatus 10 calculates and displays an estimated time of arrival ETA “08:02” and a remaining fuel Fuel “5500 LB” of the next spot MARCO and an estimated time of arrival ETA “09:25” and a remaining fuel Fuel “5250 LB” of the destination RJFR when the flight is performed according to the corrected flight profile 136 for balance priority. A balance priority icon 141 indicating the corrected flight profile 136 for balance priority is displayed. The flight support apparatus 10 calculates and displays an estimated time of arrival ETA “08:04” and a remaining fuel Fuel “5600 LB” of the next spot MARCO and an estimated time of arrival ETA “09:30” and a remaining fuel Fuel “5300 LB” of the destination RJFR when the flight is performed according to the corrected flight profile 129 manually input. A manual icon 130 indicating the corrected flight profile 129 manually input is displayed (Step S110).

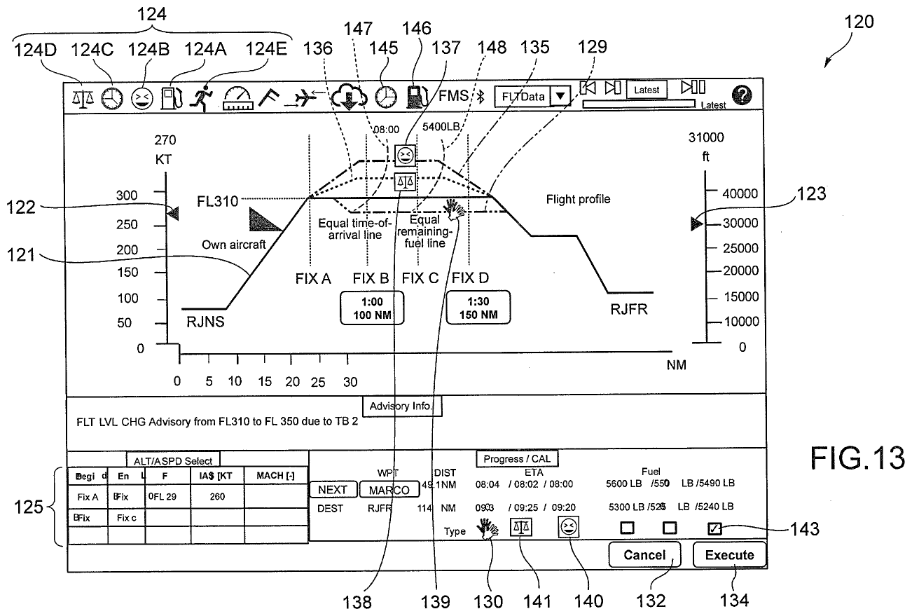

FIG. 13 shows another example of the flight support screen.

If the user does not need to prepare another corrected flight profile and to correct the corrected flight profiles 129, 135, and 136 again (Step S111, NO), the user checks a checkbox 143 indicating the corrected flight profile 135 for comfortableness priority to be selected (Step S112). The flight support apparatus 10 may propose (present) one corrected flight profile of the plurality of corrected flight profiles 129, 135, and 136 explicitly (highlighting, message, etc.) such that the user selects it as a new reference flight profile.

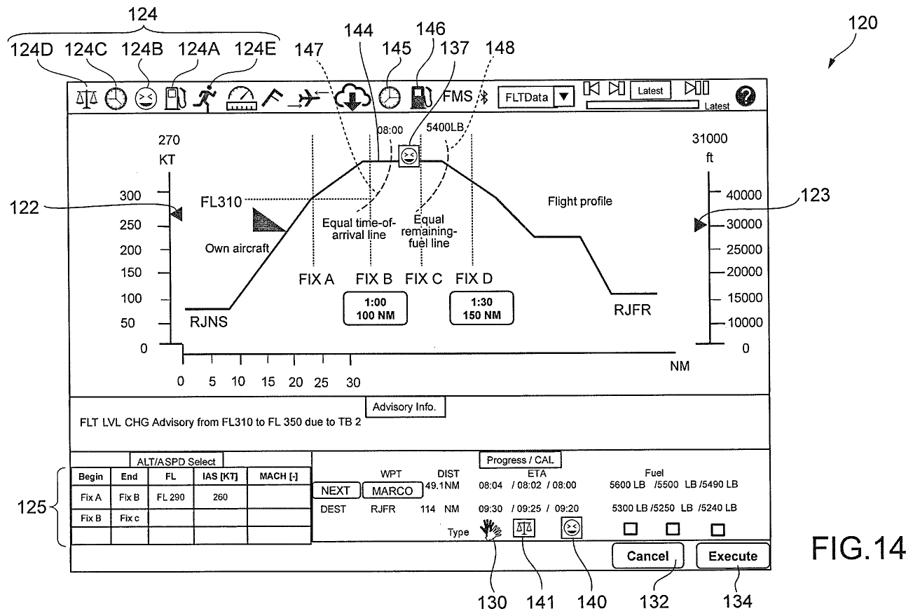

FIG. 14 shows another example of the flight support screen.

The user determines whether to set the corrected flight profile 135 for comfortableness priority, which is selected by checking the checkbox 143, as a new reference flight profile (Step S113). In other words, the user determines whether to perform a flight according to the selected corrected flight profile 135 for comfortableness priority. If the corrected flight profile 135 for comfortableness priority is set as a new reference flight profile (that is, the flight is performed according to the corrected flight profile 135 for comfortableness priority) (Step S113, YES), the user operates the Execute button 132 (Step S114). In that case, the flight support apparatus 10 deletes the display of the former reference flight profile 121, regarding the path in which the corrected flight profile 135 for comfortableness priority exists. The flight support apparatus 10 then displays the corrected flight profile 135 for comfortableness priority as a new reference flight profile 144. In other words, the flight support apparatus 10 displays the corrected flight profile 135 for comfortableness priority in the line type identical to that of the former reference flight profile 121 and thus displays the corrected flight profile 135 for comfortableness priority as a new reference flight profile 144 (Step S115).

### 4. Equal Time-Of-Arrival Line and Equal Remaining-Fuel Line

FIG. 12 will be referred to again. When the user operates an equal time-of-arrival icon 145, the flight support apparatus 10 displays an equal time-of-arrival line 147. When the user operates an equal remaining-fuel icon 146, the flight support apparatus 10 displays an equal remaining-fuel line 148. The flight support apparatus 10 displays the equal time-of-arrival line 147 and the equal remaining-fuel line 148 to propose (present) one corrected flight profile of the plurality of corrected flight profiles 129, 135, and 136 such that the user selects it as a new reference flight profile. Conversely, the user easily selects an optimal corrected flight profile as a new reference flight profile by referring to the equal time-of-arrival line 147 and the equal remaining-fuel line 148.

The equal time-of-arrival line 147 is a line (curved line or polygonal line) indicating a spot (distance NM from departure place RJNS) for which an arrival at an identical time of day (08:00) is predicted when the flight is performed using the reference flight profile 121 and the plurality of corrected flight profiles 129, 135, and 136. The flight support apparatus 10 displays the equal time-of-arrival line 147 so as to intersect with or come into contact with the reference flight profile 121 and the plurality of corrected flight profiles 129, 135, and 136. In other words, an intersection point at which each of the reference flight profile 121 and the plurality of corrected flight profiles 129, 135, and 136 intersects with or comes into contact with the equal time-of-arrival line 147 indicates a spot (distance NM from departure place RJNS) where the aircraft is located (arrives) at an identical time of day (08:00).

The equal remaining-fuel line 148 is a line (curved line or polygonal line) indicating a spot (distance NM from departure place RJNS) for which an identical amount of the remaining fuel (5400 LB) is predicted when the flight is performed using the reference flight profile 121 and the plurality of corrected flight profiles 129, 135, and 136. The flight support apparatus 10 displays the equal remaining-fuel line 148 so as to intersect with or come into contact with the reference flight profile 121 and the plurality of corrected flight profiles 129, 135, and 136. In other words, an intersection point at which each of the reference flight profile 121 and the plurality of corrected flight profiles 129, 135, and 136 intersects with or comes into contact with the equal remaining-fuel line 148 indicates a spot (distance NM from departure place RJNS) having an identical amount of the remaining fuel (5400 LB).

The flight support apparatus 10 prepares the equal time-of-arrival line 147 and the equal remaining-fuel line 148 in the background with the reference flight profile 121 as a reference. In other words, the flight support apparatus 10 prepares the equal time-of-arrival line 147 and the equal remaining-fuel line 148, which are not based on the corrected flight profiles 129, 135, and 136. Such a preparation method will be described.

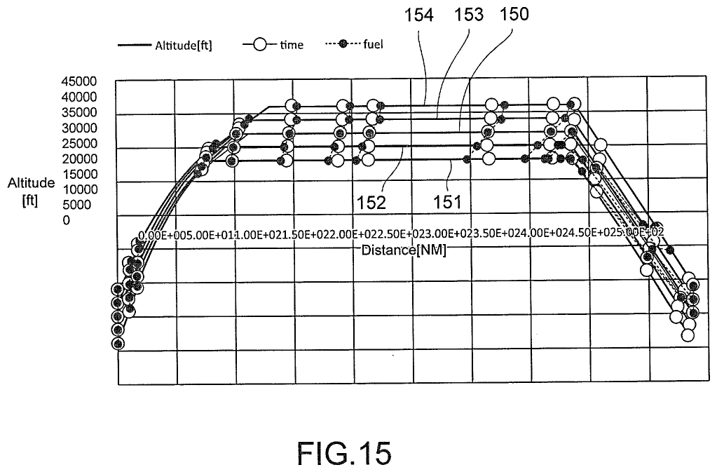

FIG. 15 shows examples of the equal time-of-arrival line and the equal remaining-fuel line.

The flight support apparatus 10 prepares a plurality of sample flight profiles 151, 152, 153, and 154 having different altitudes from a reference flight profile 150. For example, the sample flight profiles 151, 152, 153, and 154 are values obtained by respectively adding 2000 FT×(−2, −1, +1, +2) to the altitude of the reference flight profile 150.

The flight support apparatus 10 plots equal time-of-arrival points, which are spots for which the arrival at an identical time of day is predicted when the flight is performed using the reference flight profile 150 and the plurality of sample flight profiles 151, 152, 153, and 154, on the reference flight profile 150 and the plurality of sample flight profiles 151, 152, 153, and 154, respectively. For example, on the basis of time required (amount of remaining fuel) to a particular waypoint in the reference flight profile, a spot having an identical predetermined time (amount of remaining fuel) in the flight profile of each altitude only needs to be calculated as an equal time-of-arrival point (equal remaining-fuel point). The flight support apparatus 10 prepares the equal time-of-arrival line by connecting the plurality of equal time-of-arrival points plotted.

The flight support apparatus 10 plots equal remaining-fuel points, which are spots for which an identical amount of the remaining fuel is predicted when the flight is performed using the reference flight profile 150 and the plurality of sample flight profiles 151, 152, 153, and 154, on the reference flight profile 150 and the plurality of sample flight profiles 151, 152, 153, and 154, respectively. For example, on the basis of time required (amount of remaining fuel) to a particular waypoint in the reference flight profile, a spot having an identical predetermined time (amount of remaining fuel) in the flight profile of each altitude only needs to be calculated as an equal time-of-arrival point (equal remaining-fuel point). The flight support apparatus 10 prepares the equal remaining-fuel line by connecting the plurality of equal remaining-fuel points plotted.

In the above description, the flight support apparatus 10 prepares the plurality of sample flight profiles 151, 152, 153, and 154 having different altitudes from the reference flight profile 150. Instead, the flight support apparatus 10 may prepare a plurality of sample flight profiles having different speeds from the reference flight profile (not shown). In such a case, the sample flight profiles only need to be values obtained by respectively adding an instruction airspeed (IAS) 10KT, Mach 0.02×(−2, −1, +1, +2) to the speed of the reference flight profile.

### 5. Application Examples

In this embodiment, the pilot (user) carries the flight support apparatus 10 to the cockpit of the aircraft and uses it during flight. In addition, this embodiment can implement, for example, the following application examples (each of which is not shown).

An application example 1 relates to an automated flight support system. The user selects an optimal flight profile by using the flight support apparatus 10. The flight support apparatus 10 transmits the selected flight profile to a control system of the aircraft. The control system of the aircraft receives the selected flight profile and performs an automated flight according to the selected flight profile. The user may be a pilot of the aircraft or may be a person who remotely guides the aircraft from the ground. The transmission to the control system of the aircraft may be performed when the information calculated on the ground is transferred by a data link. Further, the information calculated on the ground may be converted into a remote automatic path guide command at once and transferred to the aircraft and then directly reflected in an airborne operation apparatus.

An application example 2 relates to a flight help system. The pilot operates the flight support apparatus 10 by a predetermined method (e.g., operates a help button of the aircraft) within the aircraft in an ordinary flight or an extraordinary flight (at the time of high workload such as engine trouble). In that case, the flight support apparatus 10 transmits aircraft information to the control system on the ground and also prepares an optimal flight profile to propose it so as to advise the user.

An application example 3 relates to an automated flow control system. The flight support apparatus 10 is utilized to adjust times of takeoff of a plurality of aircrafts.

An application example 4 relates to a peer-to-peer automated flight support system. A plurality of flight support apparatuses 10 within a plurality of aircrafts perform automated flight while mutually exchanging information or support the flight by pilots.

### 6. Conclusion

According to this embodiment, the flight support apparatus 10 corrects the reference flight profile according to the flight condition input by the user to prepare a corrected flight profile and display the prepared corrected flight profile together with the reference flight profile.

In an actual operation of the aircraft, the pilot may voluntarily change the flight path by the pilot's own determination. In this regard, in this embodiment, the flight support apparatus 10 displays the corrected flight profile together with the reference flight profile, so that situation awareness of the user (pilot) is enhanced and the user easily selects an optimal corrected flight profile. This achieves a cooperative decision on the flight path by the flight support apparatus 10 and the pilot. In other words, this makes it possible to make decision on the flight path by cooperation of the flight support apparatus 10 and the pilot, instead of unilaterally presenting a flight path to the user. This makes it possible for the flight support apparatus 10 to support a flight by cooperating with the pilot.

According to this embodiment, it is further expected to collaterally obtain the following effects of: improving operation efficiencies (fuel efficiency, punctuality, shake, earliest arrival); reducing the workload of the pilot; improving the skill of the pilot regarding the operation quality; serving to a reflection of the pilot, transfer of the technology, and education; leading to an optimal operation and an increase in airport capacity including other aircrafts; being capable of providing low-cost air tickets and simultaneously respecting punctuality; and improving the degree of satisfaction of passengers to the operation.

The flight profile is a line obtained by, when one of axes in two-dimensional coordinates (horizontal axis) is a distance NM from a departure place and the other axis (vertical axis) is an altitude FT, connecting points each indicating the distance NM and the altitude FT at the plurality of spots.

In this embodiment, the corrected flight profile and the reference flight profile are graphically shown on the two-dimensional coordinates of the distance and the altitude, and thus the user easily understands a difference in altitude or time between the corrected flight profile and the reference flight profile. This enhances situation awareness of the user (pilot) and makes it easy for the user to select an optimal corrected flight profile.

The flight support apparatus 10 corrects the corrected flight profile again according to the flight condition input by the user to prepare another corrected flight profile, and displays the other corrected flight profile prepared together with the reference flight profile and the corrected flight profile before corrected again.

Thus, the corrected flight profile presented by the flight support apparatus 10 is further corrected again by the determination of the user, so that a flight profile that is optimized and intended by the user is prepared. For example, the altitude/speed can be partially changed in any spot in the corrected flight profile. This achieves a more cooperative decision on the flight path by the flight support apparatus 10 and the pilot. In other words, the user further partially changes the flight profile presented by the flight support apparatus 10, so that it is possible to cooperatively decide a flight profile and cooperatively support the flight.

The flight support apparatus 10 displays the equal time-of-arrival line indicating spots, for which the arrival at an identical time of day is predicted, so as to intersect with or come into contact with the reference flight profile and the corrected flight profile.

The intersection point at which each of the reference flight profile and the corrected flight profile intersects with or comes into contact with the equal time-of-arrival line indicates a spot where the aircraft is located (arrives) at an identical time of day. With the equal time-of-arrival line as an index, the user can compare the times of arrival in the plurality of flight profiles, which is effective in the operation. The user can intuitively understand the difference between the reference flight profile and the corrected flight profile by referring to the equal time-of-arrival line, and can thus more easily select an optimal corrected flight profile.

The flight support apparatus 10 displays the equal remaining-fuel line indicating spots, for which an identical amount of the remaining fuel is predicted, so as to intersect with or come into contact with the reference flight profile and the corrected flight profile.

The intersection point at which each of the reference flight profile and the corrected flight profile intersects with or comes into contact with the equal remaining-fuel line indicates a spot having an identical amount of the remaining fuel. With the equal time-of-arrival line as an index, the user can compare the amounts of the remaining fuel in the plurality of flight profiles, which is effective in the operation. The user can intuitively understand the difference between the reference flight profile and the corrected flight profile by referring to the equal remaining-fuel line, and can thus more easily select an optimal corrected flight profile.

The flight support apparatus 10 displays one corrected flight profile, which is selected by the user from the corrected flight profiles, as a new reference flight profile.

The flight support apparatus 10 sets the corrected flight profile, which is prepared according to the flight condition input by the user, as a new reference flight profile. This achieves a cooperative decision on a flight path by the flight support apparatus 10 and the pilot. In other words, this makes it possible to make decision on the flight path by cooperation of the flight support apparatus 10 and the pilot, instead of unilaterally presenting a flight path to the user.

The flight condition input by the user includes at least one spot of the plurality of spots and a flight specification in a path including the at least one spot.

The user can input a flight condition that means a flight with a particular flight specification in a path including a particular spot. This makes it possible for the flight support apparatus 10 to prepare a flight profile closed to the user's desire. This further makes it possible to make decision on the flight path by cooperation of the flight support apparatus 10 and the pilot.

The flight condition input by the user includes at least one of fuel efficiency priority, comfortableness priority, punctuality priority, or balance priority.

This makes it possible for the flight support apparatus 10 to automatically prepare and display a flight profile according to the viewpoint intended by the user.

The flight support apparatus 10 prepares the corrected flight profile on the basis of information relating to a flight environment.

The flight support apparatus 10 can prepare the corrected flight profile in real time, for example, on the basis of weather forecast data and flight data and further information obtained by correcting those pieces of data, as the information relating to the flight environment.

The flight support apparatus 10 determines a shake of the flight support apparatus on the basis of an acceleration detected by the acceleration sensor 18, and corrects the information relating to the flight environment on the basis of the shake.

This makes it possible for the flight support apparatus 10 to determine a shake of the flight support apparatus 10 on the basis of the acceleration detected by the built-in acceleration sensor 18 and to calculate a shake of the aircraft. The flight support apparatus 10 can correct the information relating to the flight environment in real time during flight on the basis of the calculated shake of the aircraft. This makes it possible to prepare the corrected flight profile more suitably on the basis of the real-time information.

Each embodiment and each modified example of the present technology have been described above, but the present technology is not limited to the embodiment described above and can be variously modified as a matter of course without departing from the gist of the present technology.

### REFERENCE SIGNS LIST

1 flight support system
10 flight support apparatus
110 flight support unit
120 flight support screen
121 reference flight profile
122 speed indicator
123 altitude indicator
124 optimization button group
124A fuel efficiency priority button
124B comfortableness priority button
124C punctuality priority button
124D balance priority button
124E earliest arrival priority button
125 pallet
126 manual button
129 corrected flight profile
133 reference flight profile
135 corrected flight profile
136 corrected flight profile
144 reference flight profile
147 equal time-of-arrival line
148 equal remaining-fuel line

1. A flight support apparatus, comprising
a flight support unit that
displays a reference flight profile that is a flight profile as a reference, the flight profile indicating a flight specification at a plurality of spots included in a path from a departure place to a destination,
corrects the reference flight profile according to a flight condition input by a user to prepare a corrected flight profile, and
displays the prepared corrected flight profile together with the reference flight profile.

2. The flight support apparatus according to claim 1, wherein
the flight profile is a line obtained by, when one of axes in two-dimensional coordinates is a distance from the departure place and another axis is the flight specification, connecting points each indicating the distance and the flight specification at the plurality of spots.

3. The flight support apparatus according to claim 1, wherein
the flight support unit
corrects the corrected flight profile again according to a flight condition input by the user to prepare another corrected flight profile, and
displays the other corrected flight profile prepared together with the reference flight profile and the corrected flight profile before corrected again.

4. The flight support apparatus according to claim 1, wherein
the flight support unit
prepares a plurality of sample flight profiles having different flight specifications from the reference flight profile,
plots equal time-of-arrival points on the reference flight profile and the plurality of sample flight profiles, the equal time-of-arrival points being spots for which an arrival at an identical time of day is predicted when a flight is performed using the reference flight profile and the plurality of sample flight profiles,
connects the plurality of equal time-of-arrival points plotted to prepare an equal time-of-arrival line, and
displays the prepared equal time-of-arrival line to intersect with or come into contact with the reference flight profile and the corrected flight profile.

5. The flight support apparatus according to claim 1, wherein
the flight support unit
prepares a plurality of sample flight profiles having different flight specifications from the reference flight profile,
plots equal remaining-fuel points on the reference flight profile and the plurality of sample flight profiles, the equal remaining-fuel points being spots for which an identical amount of the remaining fuel is predicted when a flight is performed using the reference flight profile and the plurality of sample flight profiles,
connects the plurality of equal remaining-fuel points plotted to prepare an equal remaining-fuel line, and
displays the prepared equal remaining-fuel line to intersect with or come into contact with the reference flight profile and the corrected flight profile.

6. The flight support apparatus according to claim 1, wherein
the flight support unit proposes that the user selects one corrected flight profile of the corrected flight profiles as the reference flight profile newly set.

7. The flight support apparatus according to claim 1, wherein
the flight support unit displays one corrected flight profile, which is selected by the user from the corrected flight profiles, as the reference flight profile newly set.

8. The flight support apparatus according to claim 1, wherein
the flight condition input by the user includes
at least one spot of the plurality of spots, and
a flight specification in a path including the at least one spot.

9. The flight support apparatus according to claim 1, wherein
the flight condition input by the user includes at least one of fuel efficiency priority, comfortableness priority, punctuality priority, earliest arrival priority, or balance priority between at least two of them.

10. The flight support apparatus according to claim 1, wherein
the flight support unit prepares the corrected flight profile on a basis of information relating to a flight environment.

11. The flight support apparatus according to claim 1, further comprising
an acceleration sensor, wherein
the flight support unit
determines a shake of the flight support apparatus on a basis of an acceleration detected by the acceleration sensor, and
corrects the information relating to the flight environment on a basis of the shake.

12. A non-transitory computer-readable recording medium storing a flight support program, which causes a control circuit of a flight support apparatus to:
display a reference flight profile that is a flight profile as a reference, the flight profile indicating a flight specification at a plurality of spots included in a path from a departure place to a destination,
correct the reference flight profile according to a flight condition input by a user to prepare a corrected flight profile, and
display the prepared corrected flight profile together with the reference flight profile.

13. A flight support system, comprising:
a server that collects information relating to a flight environment and supplies the information to an flight support apparatus; and
the flight support apparatus including a flight support unit that
displays a reference flight profile that is a flight profile as a reference, the flight profile indicating a flight specification at a plurality of spots included in a path from a departure place to a destination,
corrects the reference flight profile according to a flight condition input by a user on a basis of the information relating to the flight environment to prepare a corrected flight profile, and
displays the prepared corrected flight profile together with the reference flight profile.
